(19) United States
(12) Patent Application Publication
(10) Pub. No.: US 2006/0114102 A1
(43) Pub. Date: Jun. 1, 2006

(54) High performance RFID system and operating method thereof

(75) Inventors: Shao-Chang Chang, Taipei City (TW); Ching-Hung Wu, Taichung City (TW); Shang-Wei Chen, Tainan City (TW); Yuh-Jou Tsen, Kaohsiung City (TW); Tzyh-Chiang Oscal, Yonghe City (TW); Fu-Chien Yung, Kaohsiung County (TW)

Correspondence Address: HDSL, 4331 STEVENS BATTLE LANE, FAIRFAX, VA, 22033, US

(73) Assignee: Industrial Technology Research Institute

(21) Appl. No.: 11/082,840

(22) Filed: Mar. 18, 2005

(30) Foreign Application Priority Data
Nov. 26, 2004 (TW) 093136402

(51) Int. Cl. H04Q 5/22

(52) U.S. Cl. 340/10.1

(57) ABSTRACT

A high performance Radio Frequency Identification (RFID) system and the operating method thereof. The RFID system includes a reader, a plurality of passive tags, and at least one local reader to communicate with nearby passive tags and further forward results to the reader. A repeater tag or a semi-active tag can serve as a local reader. An operating method of the high performance RFID system, a repeater tag operating method, a semi-active tag electric power detecting method, and an operating method for searching for no electric power tags are further provided.

### BACKGROUND OF THE INVENTION

The present invention relates in general to a high performance Radio Frequency Identification (RFID) system and the operating method thereof, and more particularly, to a RFID system that utilizes repeater tags as local readers to communicate with nearby passive tags and to forward retrieving data to a reader.

The demand for RFID System has been increasing in the recent years. Further, Wal-Mart, a leading grocery store company, requests that its 100 largest suppliers begin adopting RFID system before Jan. 1, 2005. Accordingly, RFID technology has increasingly become a development and research object among related businesses and laboratories.

The application of RFID system is very widespread. It can be applied to something as small as a door security device for home use, or to something as big as a supply chain network management system. RFID system has many applications which include animal chips, vehicle anti-theft systems, parking lot gate controls, production line automations, raw material managements, aviation businesses, fire-protections, livestock growing businesses, traffic controls, employee controls. Currently RFID is being combined with other technologies in the hope that other applications will be developed. For example, combining RFID with blue tooth technology so as to attain a low power consuming rate and a rapid response time; combining with sensor technology so as to wirelessly inspect surrounding and quickly read data.

A thorough RFID system consists essentially of three major parts, an application system A1, a reader A2, and tags A3, as shown in FIG. 1. The operating method thereof is as follows. The application system A1 transmits an instruction to the reader A2. The reader A2 then emits an electromagnetic wave with a specified frequency to trigger tags A3 that will then reply its identification code to the reader A2. The reader A2 identifies the identification codes from the tags A3 and then further forwards them to the application system A1 for further identification.

FIG. 2 is a block diagram of passive tag circuitry. Tag A3 receives energy and signal from the reader A2 through an antenna. A radio frequency front end circuit A31 is able to produce direct current from the energy received, to demodulate the modulation signal, and to produce a clock signal. Thus, the chip needs not to use an exterior battery. The direct current should provide sufficient operating voltage as well as energy. The demodulated signal will be input to a signal processing unit A32 for processing the instruction or the identification code. The signal processing unit A32 retrieves the identification code from a memory unit A33, and return the signal to the RF Front End circuit A31. The signal can be transmitted back to the reader A2 either by using a RFID backscatter technology or by a power amplifier. Mentioned is the essential operating mechanism of a tag. The operating mechanism using electromagnetic wave as its energy source has at least three defects that are described below.

First, the readable distance of the mechanism is short. To enable the inner circuit thereof to operate, the tag A3 must be located within a specific range from the reader A2, because the energy of the tag A3 depends totally on the electromagnetic wave emitted from the reader A2. Ordinarily speaking, when designing the inner circuit of the tag A3, engineers will choose a low power circuit. Nonetheless, no matter how low the power requirement, the tag A3 consumes power. Because the energy of the tag A3 comes from the electromagnetic wave received, the readable distance thereof is shorter than that of a wireless receiver which only receives signals.

Second, the transmission rate of the mechanism is low. The energy supplied to the tag A3 is limited. The digital circuit thereof using clock signal for processing data consumes energy. The higher the clock signal's frequency is, the more the digital circuit consumes energy. To reduce energy consuming, the clock signal's frequency must be reduced as low as possible. Thus, the data processing speed of the digital circuit becomes slower. The bit numbers per second returned to the reader A2 is accordingly low. The transmission rate of the tag A3 is, therefore, relatively low.

Third, the system function of the mechanism is limited. The tags A3 are also limited in function because of the above stated energy problem. Ordinary speaking, the main function of the tag A3 is to provide identification. However, RFID's application has been becoming more and more widespread. Simply receiving data and returning identification code, or processing some anti-collision algorithm is possibly not sufficient for utilization in new area. To expand the functions of the tag A3, adding extra hardware devices onto the tag A3 is inevitable in the future. But, the extra hardware device will burden the tag A3 with extra energy consumption, thereby rendering limitation on development of RFID's functions.

Consequently, how to remedy the abovementioned defects has become an important issue among persons skilled in the art.

Seeing the abovementioned defects of a conventional RFID system, the inventor of the subject invention realizes that to perfect the RFID system, the tag circuit must acquire ample energy so that it can provide a longer readable distance, higher transmission rate, and a more robust functional service. After an intensive effort, the inventor finally conceived of a method to remedy the above problem hoping to provide the industry a more convenient and practical RFID system.

### BRIEF SUMMARY OF THE INVENTION

The present invention provides a high performance RFID System and the operating method thereof. The high performance RFID system utilizes repeater tags as local readers to communicate with nearby passive tags and to forward retrieving data to a reader.

The present invention further provides a tag having an electric energy storage cell. Said tag can be converted into a repeater tag to detect tags, which either have lost their power or haven't energy to communicate with a remote reader, among a cluster of tags. The tag having electric power can be a temporary local reader for reading nearby tags' battery conditions.

To attain the ends of the present invention, the following methods and devices are proposed.

First, the tag becomes a local reader. Except the active transmission function, the tag having an electric energy storage cell can further develop into a local reader. The theory rests on that the distances between tags are always shorter than the distance between a tag and a reader. If some tags, among a cluster of tags, without electric power or haven't enough energy to communicate with a remote reader, the tag having electric power can be a temporary local reader to read nearby tags' data.

Second, the tag serves as a monitor. The reader of an ordinary RFID system does not have the electric power detecting ability. Therefore, among a cluster of tags whether have installed a battery or not, how to detect the electric power of the tag with a battery is important. The local reader serving as a monitor is very suitable. The local reader receives a reader's commands and is responsible to monitor other tags' battery conditions. When the reader needs the information of battery conditions, the reader sends a command to the local reader ordering the local reader to return data.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

These as well as other features of the present invention will become more apparent upon reference to the drawings therein:

FIG. 1 is a block diagram of a conventional RFID system.

FIG. 2 is a block diagram of a conventional tag.

FIG. 3 is a schematic diagram of a high performance RFID system of the present invention.

FIG. 4 is a block diagram of a repeater tag of the present invention.

FIG. 4(a) is a flow chart illustrating the operating method of the repeater tag.

FIG. 5 is a block diagram of a semi-active tag of the present invention.

FIG. 5(a) is a flow chart for detecting the electric power of the semi-active tag of FIG. 5.

FIG. 5(b) is another flow chart for detecting the electric power of the semi-active tag of FIG. 5.

FIG. 6 is a schematic diagram illustrating an operating method for searching for the semi-active tags that have lost their electric powers.

FIG. 7 shows a passive circuit being added onto the semi-active tag.

FIG. 8 is a schematic diagram illustrating another operating method for searching for the semi-active tags that have lost their electric powers.

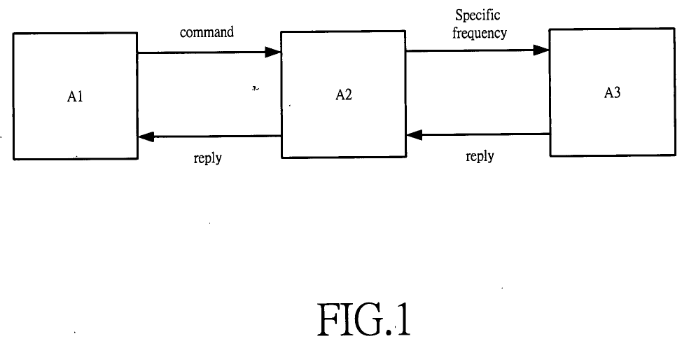

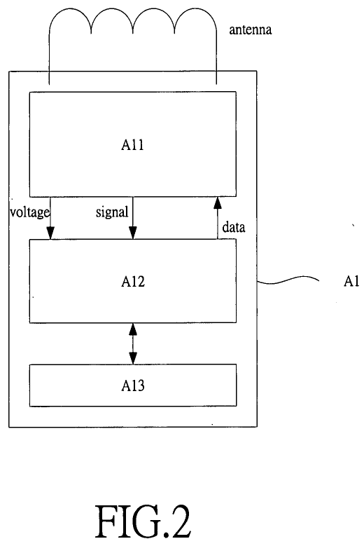

### DETAILED DESCRIPTION OF THE INVENTION

Reference will now be made in detail to the preferred embodiments of the present invention, examples of which are illustrated in the accompanying drawings. Wherever possible, the same reference numbers are used in the drawings and the description to refer to the same or like parts.

The present invention provides a high performance RFID system and the operating method thereof. A conventional reader is unable to activate a long distance passive tag through the electromagnetic wave thereof. To help the reader to acquire data from a long distance passive tag, a repeater tag, which is capable of emitting electromagnetic wave, is utilized as a local reader to communicate with nearby passive tag and to forward retrieved data to the reader. In other words, the long distance passive tag is activated by the electromagnetic wave emitted from the repeater tag instead from the reader. Thus, the RFID system is more powerful.

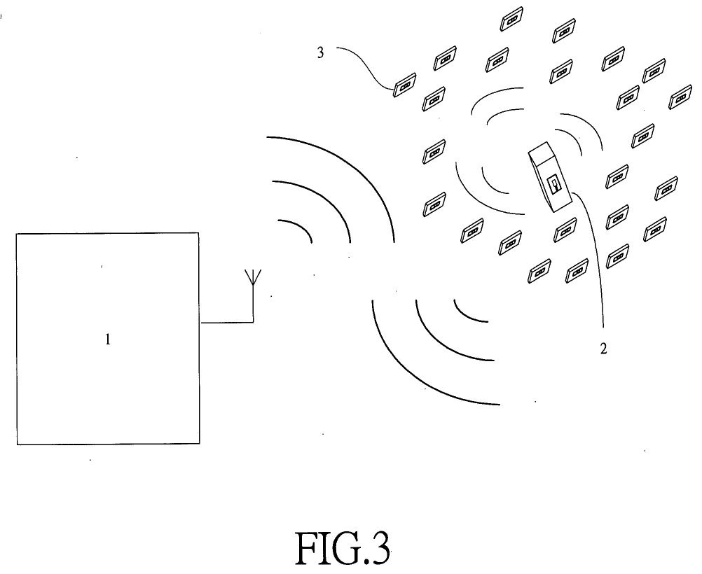

Referring to FIG. 3, a schematic diagram of a high performance RFID system of the present invention is shown. The high performance RFID system includes a reader 1, a repeater tag 2, and a plurality of passive tags 3. Among the plurality of passive tags 3, the repeater tag 2 is disposed as a local reader in order to provide energy to and to communicate with nearby passive tags 3. The communication between the repeater tag 2 and the passive tag 3 includes anticollision algorithms, reading or writing data into the tag 3, ISO 18000 commands, or even a kill command. The reader 1 emits an electromagnetic signal transmitting commands to the repeater tag 2. The repeater tag 2 then acts as a local reader and starts communicating with nearby tags 3. The content and scope of the communication between the repeater tag 2 and the tags 3 is the same as that between the reader 1 and the tag 3. The repeater tag 2 further organizes the information from the tag 3 and returns it to the reader 1.

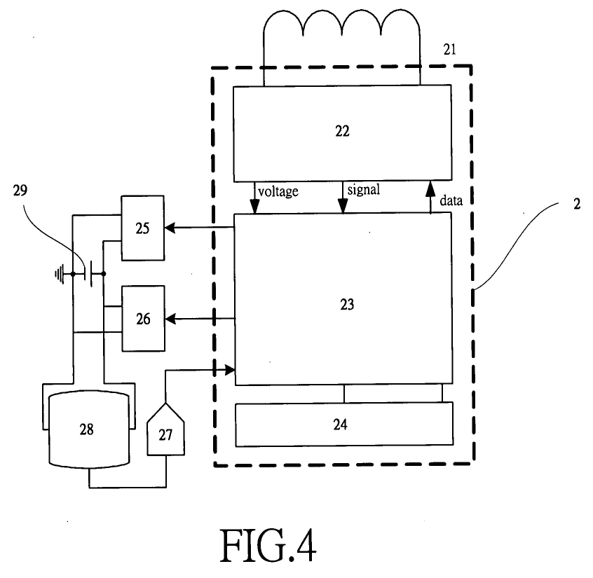

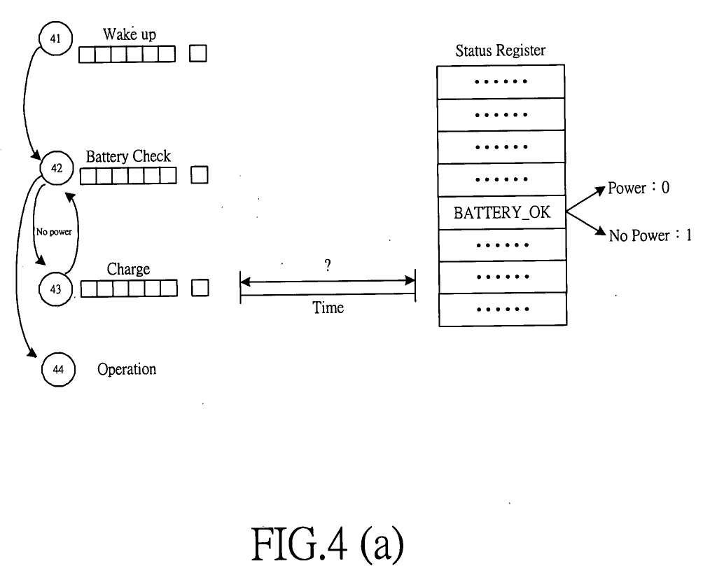

Referring to FIG. 4, a block diagram of a repeater tag of the present invention is shown. The repeater tag 2 includes an antenna 21 for transmitting and receiving signal; a radio frequency front end circuit 22 for rectifying the signal received; a digital processing unit 23 for decoding the signal and proceeding with a corresponding action; a memory 24 for data storage; a battery power detecting circuit 25 for battery power inspection; a battery replenishing circuit 26 for battery charging; an analog to digital converter 27 converting analog signals into digital signals; a sensor 28 for detecting surrounding condition such as temperature, pressure, and so on; and a battery 29 for storing electric power.

Referring to FIG. 4(a), a flow chart illustrating the operating method of the repeater tag is shown. The repeater tag 2 cooperates with the reader 1 to proceed with identification. The operating method includes the following steps.

Step 41, waking up a specified repeater tag. The reader 1 transmits a wake-up command to activate a sleeping repeater tag 2 (each square space represents a bit, and a command is made up by six bits and one parity check bit)

Step 42, transmitting a battery check command for detecting the repeater tag's battery condition. The battery check command is an application specific command designed by the applicant. The reader 1 initiates the battery check command and transmits it to the repeater tag 2. The repeater tag 2, accordingly, activates its batter power detecting circuit 25 to check the battery power thereof, and returns the result to the reader 1 through a backscatter method. The repeater tag 2 further stores the result at a status register; if the battery has sufficient electric power, a “BATTERY_OK” (designed by the applicant) will be set “0”, otherwise, the “BATTERY_OK” will be set “1”. The repeater tag 2 with sufficient electric power will then enter into a sleeping status. The repeater tag 2 without sufficient electric power will continue to standby and wait for the next command.

Step 43, transmitting a battery charging command for activating a specified repeater tag to charge the battery thereof. The battery charging command is an application specific command designed by the applicant. The reader 1 further initiates a battery charging command. The repeater tag 2 receives the command and activates its battery replenishing circuit 26 to utilize the electromagnetic wave emitted from the reader 1 to charge its battery 29. The charging time depends on the size of the battery 29. The charging time does not have specific limit, because the energy the electromagnetic wave can provide is limited. After charging for a certain period, step 42 is repeated to check the battery conditions of each repeater tag 2. Until the repeater tags 2 within the electromagnetic field all have sufficient electric power, step 44 can then be executed.

Step 44, returning data by the repeater to the reader. The repeater tags activate nearby passive tags 3 and return retrieving data to the reader 1.

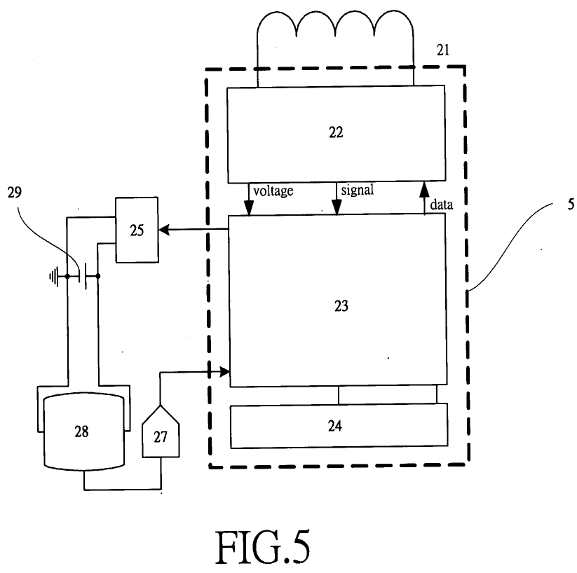

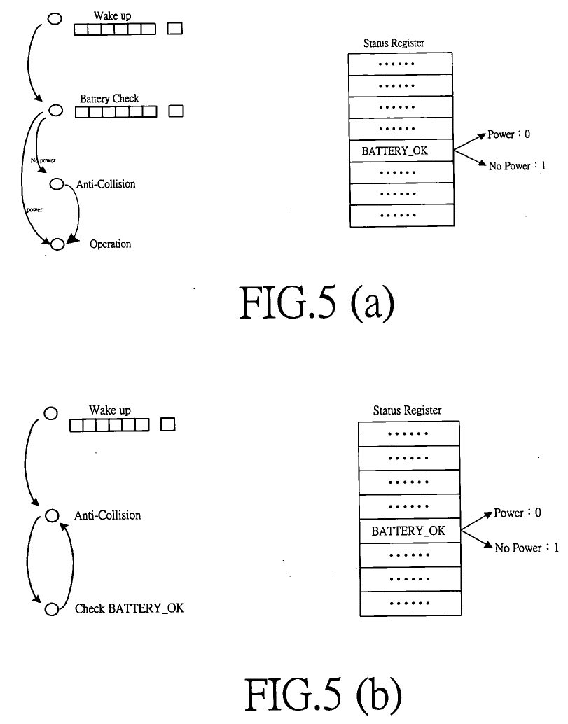

Referring to FIG. 5, a block diagram of a semi-active tag of the present invention is shown. The semi-active tag 5 is substituted for the repeater tag 2 in another embodiment of the present invention. The semi-active tag 5 includes an antenna 21 for transmitting and receiving signal; a radio frequency front end circuit 22 for rectifying the signal received; a digital processing unit 23 for decoding the signal and proceeding with a corresponding action; a memory 24 for data storage; a battery power detecting circuit 25 for battery power inspection; an analog to digital converter 27 converting analog signals into digital signals; a sensor 28 for detecting surrounding condition such as temperature, pressure, and so on; and a battery 29 for storing electric power. The circuitry of the semi-active tag 5 is similar to the circuitry of the repeater tag 2, except for the exclusion of the battery replenishing circuit. Because the electromagnetic wave emitted from the reader 1 is limited, the charging speed is relatively slow. The semi-active tag 5, therefore, deletes the battery replenishing circuit. The tag identifying method of this embodiment is similar to abovementioned method. Nonetheless, because the semi-active tags 5 uses batteries as their power sources, it is important to detect the semi-active tags 5's electric powers.

Referring to FIG. 5(a), a flow chart for detecting the electric power of the semi-active tag 5 is shown. The electric power detecting method includes the following steps.

Step 52, waking up the semi-active tags 5. The reader 1 transmits a wake-up command to activate the sleeping semi-active tags 5.

Step 53, transmitting a battery check command for detecting the semi-active tags' battery condition. The battery check command is an application specific command designed by the applicant. The reader 1 initiates a battery check command and transmits it to the semi-active tags 5. The semi-active tag 5, accordingly, activates its batter power detecting circuit 25 to check the battery power thereof, and returns the result to the reader 1 through a backscatter method. The semi-active tag 5 further stores the result at a status register; if the battery has sufficient electric power, a “BATTERY_OK” (designed by the applicant) will be set “0”, otherwise, the “BATTERY_OK” will be set “1”. The semi-active tag 5 with sufficient electric power will then enter into a sleeping status. The semi-active tag 5 without sufficient electric power will continue to standby and wait for the next command.

Step 54, detecting and searching for the semi-active tags 5 without sufficient electric power. If a semi-active tag 5 does not have sufficient electric power, the reader 1 will initiate an anticollision algorithm to identify the semi-active tag 5.

Step 55, returning data by the semi-active tag. After the semi-active tag without sufficient electric power has been identified, a corresponding action will be performed depending on their applications.

Referring to FIG. 5(b), another flow chart for detecting the electric power of the semi-active tag 5 is shown. This electric power detecting method includes the following steps.

Step 56, waking up the semi-active tags. The reader 1 transmits a wake-up command to activate the sleeping semi-active tags 5.

Step 57, randomly selecting a semi-active tag. A semi-active tag 5 is selected by means of the anticollision algorithm.

Step 58, transmitting a battery check command for detecting the electric power of the semi-active tag. The battery check command is an application specific command designed by the applicant. The reader 1 initiates a battery check command and transmits it to the selected semi-active tag 5. The semi-active tag 5, accordingly, activates its batter power detecting circuit 25 to check the battery power thereof, and returns the result to the reader 1 through a backscatter method. The semi-active tag 5 further stores the result at its status register; if the battery has sufficient electric power, the “BATTERY_OK” will be set “0”, otherwise, the “BATTERY_OK” will be set “1”. If the selected semi-active tag 5 has sufficient electric power, it will then enter into a sleeping status. If the selected semi-active tag 5 does not have sufficient electric power, it will be identified.

Step 57 and step 58 will be repeated until all of the semi-active tags 5 without sufficient power are identified.

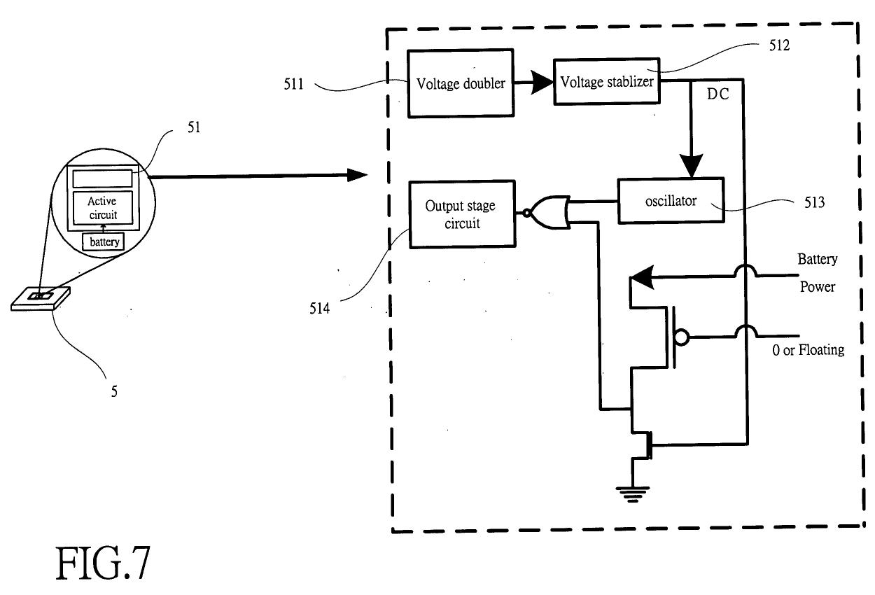

Aforementioned semi-active tag 5 is more powerful than a passive tag 3; it enables a long distance and high transmission rate communication. However, once the semi-active tag 5 has lost the battery power thereof, it is hard to find it out. Accordingly, a passive circuit 51 as shown in FIG. 7 is added onto the semi-active tag 5. The passive circuit 51 of the semi-active tag 5 includes a voltage doubler circuit 511 for escalating voltage, a voltage stablizer 512, an oscillator 513, and an output stage circuit 514 for replying signal to the reader 1.

When the semi-active tag 5 has sufficient electric power, the passive circuit 51 thereof will not transmit any signal. In contrast, when the semi-active tag 5 does not have sufficient electric power, the passive circuit 51 thereof can be activated by a repeater tag 2. The voltage doubler circuit 511 and the voltage stablizer 512 produce a direct current. The oscillator 513 produces oscillating signals. After simple logic operations, signal will be transmitted to the repeater tag 2. The passive circuit 51 does not need the digital processing unit 22, for it simply conveys the electric power status of the semi-active tag 5.

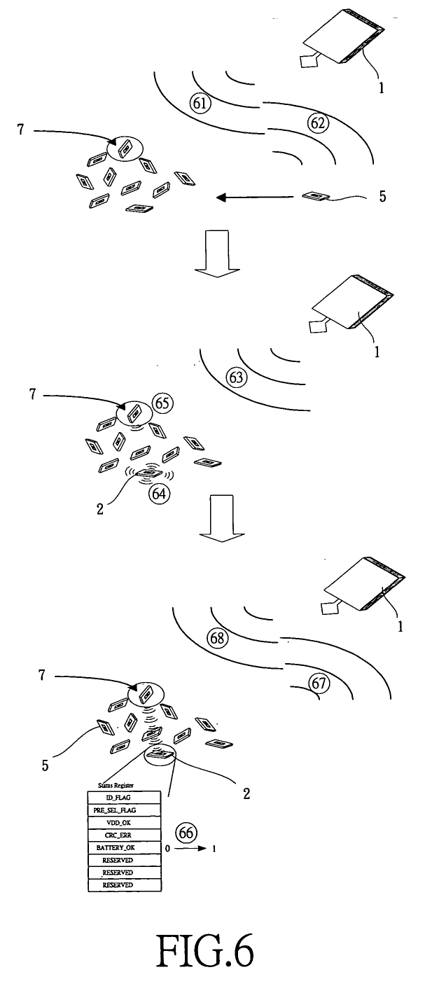

Referring to FIG. 6, a schematic diagram illustrating an operating method for searching for the semi-active tags 5 that have lost their electric powers. The operating method includes the following steps.

Step 61, transmitting a command to all tags. The reader 1 transmits a command to the semi-active tags 5. The command is similar to a command transmitted to a conventional passive tag.

Step 62, returning signals by tags. The semi-active tag 5 receives, demodulates the command signal, and further returns a signal so that the reader 1 can ascertain that the semi-active tag 5 is able to communicate back and forth with it.

Step 63, reading the tags' information. When the reader 1 has read the data of every semi-active tag 5 having electric power, it further sends out next message to choose a semi-active tag 5 already caught and requests the chosen semi-active tag 5 to emit signal to near by no electric power tags 7.

Step 64, converting semi-active tags having sufficient electric power into local readers. The specified semi-active tag 5 becomes a local reader and emits an electromagnetic wave in order to looking for no electric power tags 7.

Step 65, detecting tags' data within the electromagnetic field thereof by the local reader. The local reader uses either the backscatter technology or the power amplifier thereof to transmit energy to no electric power tags 7. The semi-active tag 5, serving as a local reader, detects if there is any no electric power tag 7 existing within the electromagnetic field thereof.

Step 66, confirming information. If the no electric power tag 7 does exist, it will reply a signal to the local reader, and the “BATTERY_OK” of the local reader will change from “0” to “1”.

Step 67, requesting for data. When the search for no electric power tags is finished, the reader 1 will send a message to the specified local reader requesting the local reader to reply that whether there is any no electric power tag 7 or not.

Step 68, returning a result by the local reader. The local reader replies a signal to the reader 1 to report the user the result.

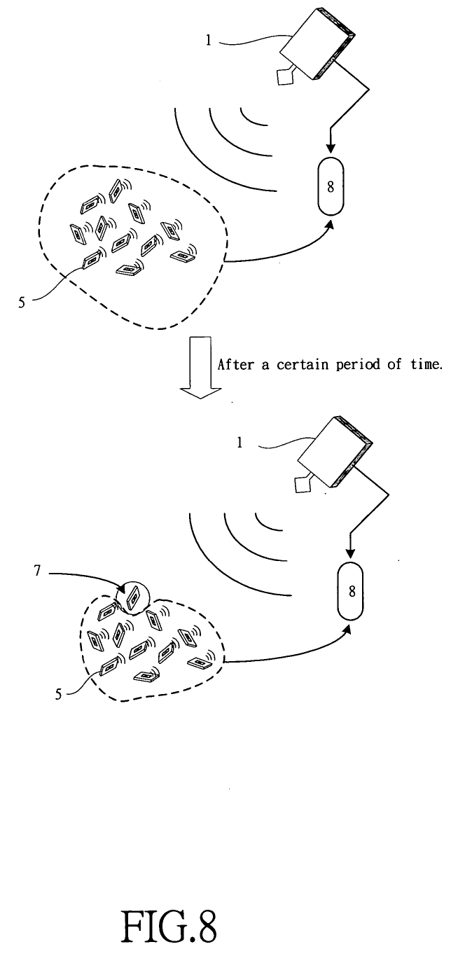

Referring to FIG. 8, a schematic diagram illustrating another operating method for searching for the semi-active tags that have lost their electric powers is shown. When the semi-active tags 5 located within an electromagnetic field of a reader 1 all have sufficient electric power, the reader 1 communicates with all of the semi-active tags 5, and records their data in a database 8 for future collation. After a certain period of time, the reader 1 again communicates with all of the semi-active tags 5 and further collates the new retrieving data with the data stored in the database 8. If the new retrieving data is different from the stored data, a semi-active tag 5 have lost its electric power and must be marked as a no electric power tag 7. Thus, the no electric power tag 7 can be quickly found out.

While an illustrative and presently preferred embodiment of the invention has been described in detail herein, it is to be understood that the inventive concepts may be otherwise variously embodied and employed and that the appended claims are intended to be construed to include such variations except insofar as limited by the prior art.

What is claimed is:

1. A high performance Radio Frequency Identification (RFID) system, comprising:
a reader;
a plurality of passive tags; and
at least one local reader to communicate with nearby passive tags and further forward results to the reader.

2. An operating method of the high performance RFID system of claim 1, comprising the steps of:
transmitting commands by the reader to a local reader;
relaying signal by the local reader to nearby passive tags;
relying information by the passive tags to the local reader; and
organizing and forwarding data by the local reader to the reader.

3. The high performance RFID system of claim 1, wherein the local reader is a repeater tag comprising:
an antenna for transmitting and receiving signal;
a radio frequency front end circuit for rectifying the signal received;
a digital processing unit for decoding the signal and proceeding with a corresponding action;
a memory for data storage;
a battery power detecting circuit for battery power inspection;
a battery replenishing circuit for battery charging;
an analog to digital converter converting analog signals into digital signals;
a sensor for detecting surrounding condition such as temperature, pressure, and so on; and
a battery for storing electric power.

4. An operating method of the repeater tag of claim 3 as a local reader, comprising the steps of:
waking up a specified repeater tag;
transmitting a battery check command for detecting the repeater tag's battery condition;
transmitting a battery charging command for activating a specified repeater tag to charge the battery thereof; and
returning data by the repeater to the reader.

5. The operating method of claim 4, wherein the step “transmitting a battery check command for detecting the repeater tag's battery condition” uses an application specific command designed by the applicant for detecting battery power.

6. The operating method of claim 4, wherein, at step “transmitting a battery check command for detecting the repeater tag's battery condition,” the repeater tag replies to the reader by means of a backscatter technology.

7. The operating method of claim 4, wherein setting a “BATTERY_OK” of a status register of the repeater tag is an application specific command designed by the applicant.

8. The high performance RFID system of claim 1, wherein the local reader is a semi-active tag comprising:
an antenna for transmitting and receiving signal;
a radio frequency front end circuit for rectifying the signal received;
a digital processing unit for decoding the signal and proceeding with a corresponding action;
a memory for data storage;
a battery power detecting circuit for battery power inspection;
an analog to digital converter converting analog signals into digital signals;
a sensor for detecting surrounding condition such as temperature, pressure, and so on; and
a battery for storing electric power.

9. A semi-active tag electric power detecting method, comprising the steps of:
waking up the semi-active tags.
transmitting a battery check command for detecting the semi-active tags' battery condition;
detecting and searching for the semi-active tags without sufficient electric power.
returning data by the semi-active tag.

10. The semi-active tag electric power detecting method of claim 9, wherein the step “transmitting a battery check command for detecting the semi-active tags' battery condition” uses an application specific command designed by the applicant for detecting battery power.

11. The semi-active tag electric power detecting method of claim 9, wherein, at step “transmitting a battery check command for detecting the semi-active tags' battery condition,” the semi-active tags reply to the reader by means of the backscatter technology.

12. The semi-active tag electric power detecting method of claim 9, wherein setting a “BATTERY_OK” of a status register of the semi-active tag is an application specific command designed by the applicant.

13. The semi-active tag electric power detecting method of claim 9, wherein the step “detecting and searching for the semi-active tags without sufficient electric power” utilizes an anti-collision technology to search for the semi-active tags without sufficient electric power.

14. A semi-active tag electric power detecting method, comprising the steps of:
waking up the semi-active tags;
randomly selecting a semi-active tag; and
transmitting a battery check command for detecting the electric power of the semi-active tag.

15. The semi-active tag electric power detecting method of claim 14, wherein the step “randomly selecting a semi-active tag” utilizes the anti-collision technology.

16. The semi-active tag electric power detecting method of claim 14, wherein the step “transmitting a battery check command for detecting the electric power of the semi-active tag” uses an application specific command designed by the applicant for detecting battery power.

17. The semi-active tag electric power detecting method of claim 14, wherein, at step “transmitting a battery check command for detecting the electric power of the semi-active tag,” the semi-active tags reply to the reader by means of the backscatter technology.

18. The semi-active tag electric power detecting method of claim 14, wherein setting the “BATTERY_OK” of the status register of the semi-active tag is an application specific command designed by the applicant.

19. The high performance RFID system of claim 8, wherein the semi-active tag further includes a passive circuit, comprising:
a voltage doubler circuit for escalating voltage;
a voltage stablizer for stabilizing the operating voltage;
an oscillator for generating oscillating signal; and
an output stage circuit for replying signal to the reader.

20. An operating method for searching for no electric power tags, comprising the steps of:
transmitting a command to all tags;
returning signals by tags;
reading the tags' information;
converting semi-active tags having sufficient electric power into local readers;
detecting tags' data within the local reader's electromagnetic field;
confirming information;
requesting for data; and
returning a result;

21. The operating method for searching for no electric power tags of claim 20, wherein the step “returning signals by tags” utilizes the anti-collision technology to find out every semi-active tags having electric power.

22. The operating method for searching for no electric power tags of claim 20, wherein the step” detecting tags' data within the electromagnetic field thereof by the repeater tag” uses either the backscatter technology or the power amplifier to transmit energy to no electric power tags.

23. The operating method for searching for no electric power tags of claim 20, wherein at the step” confirming information”, if no electric power tag does exist, it will reply a signal to the repeater tag, and the “BATTERY_OK” of the repeater tag will change from “0” to “1”.
